(19) United States
(12) Patent Application Publication
(10) Pub. No.: US 2025/0250186 A1
(43) Pub. Date: Aug. 7, 2025

(54) PLASMA-ASSISTED WATER TREATMENT SYSTEM FOR ELIMINATION OF PERSISTENT ORGANIC AND INORGANIC WATER CONTAMINANTS

(71) Applicant: Moose Hill Enterprises, Inc., Sperryville, VA (US)

(72) Inventors: Oleg Dubov, Torredembarra (ES); Oleg Samsonov, Warsaw (PL)

(21) Appl. No.: 18/435,338

(22) Filed: Feb. 7, 2024

(51) Int. Cl. C02F 1/467; C02F 1/46; C02F 1/461; C02F 1/48; C02F 101/34; C02F 101/36; C02F 101/38

(52) U.S. Cl. CPC C02F 1/4676; C02F 1/4608; C02F 1/46109; C02F 1/487; C02F 2001/46152; C02F 2001/46171; C02F 2101/34; C02F 2101/36; C02F 2101/38; C02F 2201/46175; C02F 2201/4619; C02F 2301/02

(57) ABSTRACT

A method and system for treating water. A method includes providing a discharge cell having a first group of electrodes and a second group of electrodes arranged to provide a discharge zone therebetween; filling the discharge cell with a reducing gas that includes a least one reductive gas selected from a group consisting of hydrogen, a gaseous organic compound, a vapour of a volatile organic compound, carbon monoxide, ammonia, hydrazine and hydrogen sulfide; applying high voltage to the electrodes in the discharge cell to generate a plasma environment within the discharge zone that includes one of a pulsed corona or a barrier discharge; and introducing water containing persistent organic compounds or reducible inorganic compounds into the discharge zone and subjecting the water to the plasma environment to reduce the organic or inorganic compounds.

### TECHNICAL FIELD

The present invention relates to a plasma-assisted water treatment system for elimination of persistent organic water contaminants, especially halogenated organic water contaminants, and reducible inorganic water contaminants, such as heavy metal ions, arsenate-arsenite ions and others.

### BACKGROUND

Water contamination due to the presence of persistent organic and inorganic contaminants, such as perfluorinated compounds or arsenate, poses significant challenges to both human health and the environment. These compounds are known for their resistance to conventional water treatment methods, making their removal a complex and pressing concern. Existing water treatment technologies often struggle to effectively remove these contaminants, leading to their persistence in water supplies. Consequently, there is a critical need for an innovative and efficient approach to address this issue, which is the primary objective of the present invention.

### SUMMARY

The present invention addresses the challenge of eliminating persistent organic compounds, especially fluorinated, chlorinated, and brominated organic compounds, as well as reducible inorganic compounds, from contaminated water by utilizing a novel plasma-assisted water treatment system. In one aspect, a method for treating contaminated water is provided that includes: providing a discharge cell having a first group of electrodes and a second group of electrodes arranged to provide a discharge zone therebetween, filling the discharge cell with a reducing gas that includes at least one reductive gas selected from a group consisting of hydrogen, a gaseous organic compound, a vapour of a volatile organic compound, carbon monoxide, ammonia, hydrazine and hydrogen sulfide; applying high voltage to the electrodes in the discharge cell to generate a plasma environment within the discharge zone that includes one of a pulsed corona or a barrier discharge; and introducing contaminated water into the discharge zone and subjecting the contaminated water to the plasma environment to reduce at least one of persistent organic compounds or reducible inorganic compounds.

In a further aspect, a system for treating contaminated water is provided that includes: a discharge cell having a first group of electrodes and a second group of electrodes arranged to provide a discharge zone therebetween; a reducing gas configured for introduction into the discharge cell, wherein the reducing gas includes at least one reductive gas selected from a group consisting of hydrogen, a gaseous organic compound, a vapour of a volatile organic compound, carbon monoxide, ammonia, hydrazine and hydrogen sulfide; a high voltage generator configured to apply high voltage to the electrodes in the discharge cell to generate a plasma environment within the discharge zone that includes one of a pulsed corona or a barrier discharge; and an inlet for introducing contaminated water into the discharge zone and subjecting the water to the plasma environment to reduce at least one of persistent organic compounds or reducible inorganic compounds.

Further aspects may include the above aspects: wherein the reductive gas mixture further includes a non-reductive gas selected from a group consisting of nitrogen, carbon dioxide, oxygen (contained in very low amount), argon, helium or another noble gas; wherein the water further contains reducible inorganic compounds which are reduced by the plasma environment; wherein the persistent organic compounds include at least one of fluorinated, chlorinated, and brominated compounds; wherein the water is introduced using at least one of showering, pulverizing, or a free-flowing film; wherein the discharge cell includes a dielectric barrier between the first group of electrodes and second group of electrodes; wherein the water is passed through the discharge cell in a continuous flow process; wherein the contaminated water is passed through the discharge cell in a batch processing mode; wherein the plasma environment is configurable to reduce oxygen or nitrogen-containing compounds; wherein, in addition to primary reduction (halogen abstraction) processes secondary oxidation with water or traces of oxygen can take place, resulting in the formation of, for instance, ketones from polyfluorinated aliphatic compounds; wherein the first group of electrodes comprise parallel plates and the second group of electrodes comprise wires running horizontally and/or vertically between the plates; and/or wherein the first group of electrodes comprise concentric tubes and the second group of electrodes comprise wires running horizontally and/or vertically between the tubes.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 depicts a water decontamination system, in accordance with an illustrative embodiment.

FIG. 2 depicts a flow chart showing a method for treating contaminated water, in accordance with an illustrative embodiment.

FIG. 3 depicts a discharge cell with a first electrode arrangement, in accordance with an illustrative embodiment.

FIG. 4 depicts a discharge cell with a second electrode arrangement, in accordance with an illustrative embodiment.

FIG. 5 depicts a discharge cell with a third electrode arrangement, in accordance with an illustrative embodiment.

The drawings are intended to depict only typical aspects of the disclosure, and therefore should not be considered as limiting the scope of the disclosure.

### DETAILED DESCRIPTION

The present invention pertains to the field of water treatment and, more specifically, to a system for the elimination of persistent organic and inorganic contaminants, including fluorinated, chlorinated, and brominated compounds, oxygen-containing organic compounds and inorganic ions, from water sources. The invention utilizes plasma-assisted technology to achieve efficient removal of these contaminants, contributing to the improvement of water quality and environmental sustainability.

Halogenated organic compounds are widespread in the environment, and they pose serious threats to human health and ecosystems due to their toxicity, bioaccumulation, and persistence. Some examples of halogenated organic water contaminants are per- and polyfluoroalkyl substances (PFAS/PFOS), dioxins, halogenated furans, dioxin-like halogenated biphenyls, chlorinated solvents, pesticides, and disinfection by-products. Heavy metals and toxic non-metals represent a significant problem for water treatment and typically require the utilization of expensive selective adsorbents, with metals and non-metals in high oxidation states (chromates, arsenates, etc.) being the most problematic due to poor adsorption on common adsorbents.

Conventional water treatment methods have limitations in efficiently removing stubborn organic compounds. For instance, most of the compounds listed above show moderate to low adsorption capacity on activated carbon and other high-surface absorbents. Although advanced oxidation (processes based on generation of active oxygen-containing oxidative species) demonstrates decent efficiency for degradation of some halogenated compounds, that fail to reach deep degradation for polyhalogenated, especially polyfluorinated compounds. Therefore, there is a pressing need for innovative and effective technologies that can eliminate such contaminants from water sources.

The removal of heavy metals and toxic non-metal elements is generally a less complex process when compared with recalcitrant organic contaminants, though it is typically characterized by the recuperation of these elements in their original, soluble states. In contrast, plasma-assisted reduction has the capacity to yield elemental powders, enabling the direct recovery of raw metallic and non-metallic forms. This aspect is particularly pertinent in the context of galvanic wastewater treatment, where metal concentrations may reach substantial levels, often in the order of hundreds of milligrams per liter.

Furthermore, conventional remediation strategies that rely on adsorption and ion exchange processes are often ineffectual against metal and non-metal ions that exist within chelate complexes with organic or inorganic ligands—a scenario that is commonplace in galvanic wastewater streams. Plasma reduction addresses this challenge by effectuating the reduction of the complexing agents, thereby releasing the bound metals or non-metals, which are then subject to reduction to their elemental states.

The application of plasma technologies in environmental remediation is a rapidly emerging field. Plasma, often referred to as the fourth state of matter, consists of a mixture of electrons, ions, and neutral particles, and has the unique ability to produce a variety of highly reactive species. These reactive species can break down even the most recalcitrant organic pollutants, thereby offering a potential solution for the degradation of persistent organic and inorganic contaminants in water.

Advanced reduction processes, analogous to their oxidation counterparts but focusing on the transfer of electrons to contaminants, have been explored as a treatment method for various pollutants. While advanced oxidation processes can be effective against a broad spectrum of contaminants, advanced reduction methods prove to be more potent for the removal of halogenated compounds. This is primarily because these halogenated (especially polyhalogenated) compounds are already highly oxidized, making reduction-based treatments inherently more efficacious for their degradation.

However, while the promise of advanced reduction is evident, the application of plasma-based advanced reduction heretofore remains notably underexplored. Research and implementations integrating plasma into advanced reduction processes are relatively scarce, highlighting a gap in the literature and potentially untapped potential for more effective water purification strategies. In investigations pertaining to advanced reduction via non-thermal plasmas, the plasma carrier gas employed is typically an inert medium, such as argon, or nitrogen, rather than an inherently reductive gas like hydrogen.

The present approach seeks to address the aforementioned challenges by introducing a novel plasma-assisted system and method based on excitation of non-thermal plasmas, preferably pulsed corona discharge (PCD) and barrier discharge (BD) plasmas in a reducing atmosphere, e.g., a hydrogen-rich atmosphere, providing direct contact of treated liquid with cold plasma. The species generated in plasmas include free electrons, that can be directly transferred to aqueous solutions via gas-liquid interface and act as powerful reducing agents. However, the presence of a significant amount of oxygen in the plasma carrier gas drastically reduces the generation of electrons due to their scavenging by oxygen-containing species. In contrast, the presence of a reducing gas in the plasma media can increase the generation of free electrons. Moreover, electric discharges in hydrogen-rich atmosphere are known to generate short-lived atomic hydrogen, which is also transformed to solvated electrons upon contact with water. The dissolved electrons realize the reductive activity and eliminate halogens from polyfluorinated compounds, resulting in the formation of aliphatic and aromatic hydrocarbons and inorganic fluoride. It should be noted that reductive plasma conditions can frequently be established within non-oxidizing carrier gases, even in the absence of an intrinsic reductive gas component. For example, the processing of aqueous solutions containing organic compounds with argon plasma frequently culminates in the in-situ generation of hydrogen. Consequently, the imperative is to ensure an environment with the prevalence of reductive species to facilitate effective plasma-induced reduction, rather than the obligatory introduction of reductive gases per se. However, for most practical uses, the introduction of a reductive gas to the plasma gas mixture may be preferred. It should also be noted that, in the presence of a reductive gas like hydrogen, small amounts of oxygen can counterintuitively increase the efficiency of reductive plasmas by facilitating a two-step reduction-oxidation mechanism, starting from contaminant reduction with atomic hydrogen or dissolved electrons (for instance, halogen abstraction in the case of halogenated pollutants), followed by an oxidation step, resulting in the formation of less halogenated or non-halogenated aldehydes and ketones.

In cases where oxygen is utilized, care must be taken as oxygen and hydrogen and other reductive gases become explosive when they coexist in high concentrations. Accordingly, in cases involving a binary mixture, e.g., hydrogen with oxygen, the system remains operative (i.e., safe) so long as the oxygen is below half of the hydrogen's content by volume. The same applies to other reductive gases with the corresponding application of their stoichiometry coefficients for the reaction with oxygen. Thus, for example, the content of hydrogen in volume percentage (e.g., 2%) should be at least double of the oxygen's content (e.g., 1%), while the oxygen's content should not exceed 2% to ensure explosion safety.

The utilization of a reducing gas like hydrogen in plasma-based treatment has been limited to the context of gas phase reactions or surface treatments, rather than liquid phase water treatment. The present approach capitalizes on this gap by enabling efficient electron transfer to the aqueous phase, which significantly enhances the reductive dehalogenation process.

Previous techniques have introduced methods and systems for the generation of high voltage, pulsed, periodic corona discharges in the presence of conductive liquid droplets as well as stable barrier discharge in the presence of a free-flowing liquid film on the barrier material, paving the way for advancements in the purification of gaseous and liquid media. While such systems have effectively harnessed the oxidizing power of corona and barrier discharges, they have not capitalized on the profound potential of reductive gas atmospheres within the discharge zone. The present approach distinguishes itself with the innovative integration of reductive gases, such as hydrogen, as the discharge medium, which has not been conventionally employed. This novel approach exploits the inherent reductive properties of these gases to enhance the generation of solvated electrons, thereby significantly improving the efficiency of reduction and dehalogenation processes. The synergy between the pulsed corona or barrier discharge and the intrinsically reductive atmosphere provides a previously untapped mechanism for the breakdown of resistant organic and inorganic compounds, offering a new paradigm in advanced reduction processes for water treatment.

In the context of existing technologies, ultrasonic methods have shown promise due to their capability to induce cavitation effects in aqueous solutions, leading to the generation of solvated electrons. These electrons can play a pivotal role in the reduction and degradation of persistent per- and polyfluoroalkyl substances. However, the production of solvated electrons through cavitation mechanisms is often limited and requires significant energy inputs due to the need to maintain high ultrasound intensities.

Contrastingly, the plasma technology proposed in the present approach ensures a more efficient and targeted production of solvated electrons using non-thermal plasma in a reductive atmosphere. This approach not only reduces the energy expenditure compared to ultrasonic processing but also achieves a higher level of electron generation, which potentially increases the efficacy of the reduction of recalcitrant compounds. Thus, the current approach provides new opportunities for purifying water sources of persistent halogenated and some non-halogenated organic contaminants, as well as free and coordinated ions of metals and non-metals, expanding the capabilities of existing methods and offering a more advanced solution to this environmental challenge.

The present approach extends prior efforts involving the plasma treatment of water. For example, US Patent Publication US2022/0212959, filed Jan. 6, 2022, entitled Plasma Aerosol Hybrid Method for Fluoro Compound Abatement, which is hereby incorporated by reference, utilizes the afterglow region of a non-thermal plasma discharge for contaminant treatment. However, the efficiency of this method may not be optimal, as the recombination and energy loss of active particles and transient compounds in the afterglow are significantly higher compared to the active plasma zone.

PCT application WO2008008958A1, filed Jul. 13, 2007, entitled Device for Generation of Pulsed Corona Discharge, which is hereby incorporated by reference, attempts to address the direct introduction of water—as droplets, a continuous stream, or aerosols—into the active plasma discharge zone, which poses a substantial technical challenge due to the high electrical conductivity of water, which complicates the stability of the gas discharge.

The current approach enhances the pulsed corona discharge or barrier discharge concepts in a gaseous discharge zone laden with liquid, namely the use of reductive gases, providing a highly effective method for liquid treatment with exceptionally high reductive potential, employing free electrons, atomic hydrogen, and other potent reductive (and, in the secondary steps, sometimes oxidative) species.

An additional significant advantage of the present approach lies in its tolerance to liquid input with a high load of mechanical impurities. Commonly, wastewater streams, such as landfill leachate, heavily laden with polyhalogenated impurities, also carry substantial amounts of clay and other mechanical contaminants. Conventional plasma treatment systems that depend on fine aerosolization of the liquid require stringent pre-filtration to prevent clogging and maintain efficiency, which adds to the complexity and cost of the treatment process. In stark contrast, the present system's robust design permits the direct introduction of such contaminated streams, using large droplets or films, without the need or with minimal need for pre-filtration. This not only simplifies the overall treatment process but also significantly reduces the cost and time associated with pre-treatment steps. The capability to handle unfiltered and highly contaminated liquids directly translates to a broader applicability in real-world environmental clean-up scenarios, where the complexity and variability of waste streams can otherwise be a limiting factor.

A feature of the present approach is the application of high voltage, e.g., in the form of pulses, to the discharge cell, typically at voltages in the range of several tens of kilovolts (e.g., 10-100 kilovolts at 1 kilowatt), with pulse durations ranging from nanoseconds to hundreds of nanoseconds and a typical pulse repetition rate in the kilohertz range for corona discharge and DC, AC or pulsed nature of the current for barrier discharge. The discharge chamber (or cell) is filled with reductive gases, including but not limited to hydrogen, gaseous organic compounds or vapours of volatile organic compounds, carbon monoxide, ammonia, hydrazine, and hydrogen sulfide, sometimes combined with other gases such as nitrogen or inert gases.

A feature of this approach involves the use of plasma to efficiently reduce fluorinated, chlorinated, or brominated compounds, as well as some other classes of highly oxidized organic compounds (e.g. carboxylic acids, aldehydes, ketones) and inorganic compounds (heavy metals and nonmetals in ionic form) leading to their degradation and removal from the water source. This innovative approach accordingly offers a promising solution for the remediation of water contaminated with persistent organic and inorganic compounds, thereby contributing to improved water quality and environmental sustainability. The approach allows for contaminated water to be treated to levels compliant with established water quality standards.

### Illustrative Embodiments

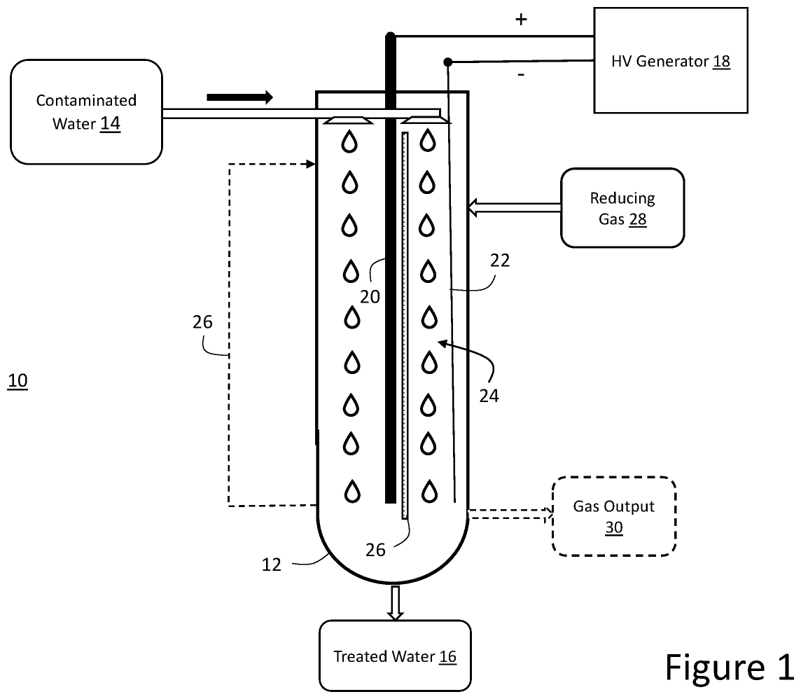

FIG. 1 depicts an illustrative water decontamination system 10 configured to receive a source of contaminated water 14 and output decontaminated or treated water 16. System 10 generally includes a discharge cell 12, a high-voltage (HV) generator 18, and a source of reducing gas 28. Reducing gas 28 is introduced into discharge cell 12, and for example includes one or more reductive gases or a mixture of one or more reductive gases and non-reductive gases. Reductive gases may for example include hydrogen, gaseous organic compounds or vapours of volatile organic compounds, carbon monoxide, ammonia, hydrazine, and hydrogen sulfide, and non-reductive gases may for example include nitrogen, carbon dioxide, oxygen, carbon dioxide, argon, helium, or another noble gas.

Selective mixtures of the gases allow for a tailored plasma environment suitable for the degradation or modification of a wide range of organic compounds.

Once the discharge cell 12 if filled with the reducing gas 28, HV generator 18 is configured to apply high voltage to a first group of electrodes 20 and a second group of electrodes 22, e.g., to generate a pulsed corona or barrier discharge within a discharge zone in the discharge cell 12. In an illustrative embodiment, HV generator 18 outputs voltages in the range of several tens of kilovolts, with pulse durations ranging from nanoseconds to hundreds of nanoseconds and a typical pulse repetition rate in the kilohertz range for pulsed corona discharge and high voltage DC, AC or pulsed feed for barrier discharge. It is understood that the parameters of the high voltage generated by HV generator 18 can vary to, e.g., be optimized for efficient plasma generation.

In certain aspects, the first group of electrodes 20 can comprise a series of flat or low curvature electrodes with suitable spacing between them. These electrodes can be arrays of rectangular plates, concentric tubes or any other geometry providing fixed distance to the second group of electrodes 22. The second group of electrodes 22 can comprise an array of high curvature electrodes with active emitting surface located at a fixed distance from one or more of the first group of electrodes 20. In such arrangements, the second group of electrodes 22 have a curvature that is substantially greater than the curvature of the first group of electrodes (e.g., the second group has a curvature radius at least twice that of the first group). The spacing between the first group of electrodes 20 and the curvature diameter of the second group of electrodes 22 can be adjusted to optimize the treatment process for specific applications. In an illustrative configuration, the spacing between the first group of electrodes and corresponding second group of electrodes 20 can range from millimeters to centimeters, depending on the desired treatment efficiency. In yet another configuration, the second group of electrodes 22 can be realized as metal wires strung in parallel between metal plates or between concentrically aligned metal tubes (i.e., the first group of electrodes 20). The first group of electrodes 20 can be solid or comprise a mesh. The described configurations allow for a type of discharge referred to as pulsed corona discharge. In other cases, the second group of electrodes may comprise a mesh, e.g., woven from metal wires. In certain cases, the mesh wires arranged between plate-like electrodes can effectively form a grid with a large distance between the constituting wires (e.g., larger than the distance to the plates).

The discharge cell 12 can optionally include an electrically insulating material 26 between the first and second groups of electrodes 20, 22. Insulating material 26 can for example comprise a dielectric material such as glass, quartz, ceramics, and polymers. When such a material is used, the type of discharge comprises a barrier discharge.

It is understood that the size, arrangement, and number of electrodes 20, 22, as well as any insulating material 26, can vary depending on the particular implementation.

Once the plasma discharge is created, contaminated water 14 is introduced into the discharge cell 12. Introduction may for example be at a low pressure and comprise droplets 24 by showering, pulverizing or as a free-flowing film on electrodes 20, 22 or the insulating barrier material 26.

Depending on the type of reducing gas 28 being used, discharge cell 12 may or may not include a gas output 30. For example, if the gas consists solely of hydrogen, gas output 30 may not be required since the hydrogen will be consumed as part of the process.

Depending on the implementation, the water may be recirculated 26 to enhance the decontamination process. In other cases, decontamination may be achieved with a single pass. Accordingly, the contaminated water 14 can be passed through the discharge cell 12 in a continuous, recirculated, or batch mode process.

System 10 accordingly provides a plasma-assisted reduction process that can result in the complete elimination of fluorinated, chlorinated, and brominated organic compounds from the contaminated water 14, as well as the elimination of reducible inorganic compounds from the contaminated water 14. In other cases, the plasma-assisted reduction process can reduce the concentration of fluorinated, chlorinated, and brominated organic compounds, as well as some oxygen and nitrogen-containing compounds and reducible inorganic compounds in the contaminated water 14 to levels compliant with established water quality standards.

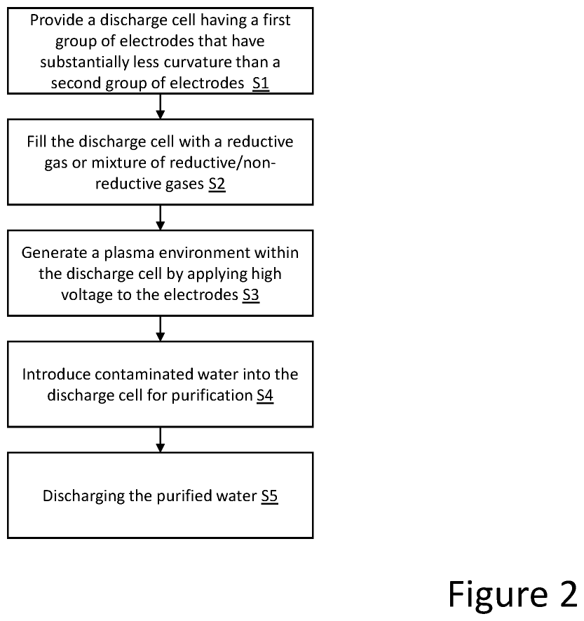

FIG. 2 depicts a flow diagram of an overview of the process. At S1, a discharge cell is provided having a first group of electrodes and a second group of electrodes. In some embodiments, the first group of electrodes have substantially less curvature than the second group of electrodes. For example, the first group of electrodes may comprise parallel plates or concentric tubes, and the second group of electrodes may comprise thin wires having substantially round cross sections arranged between the first group of electrodes. In other cases, the second group of electrodes may for example comprise a wire mesh configuration. Next, at S2, the discharge cell is filled with a reducing gas, e.g., a reductive gas or a mixture of reductive/non-reductive gases. Reductive gases may for example include hydrogen, gaseous organic compounds or vapours of volatile organic compounds, carbon monoxide, ammonia, hydrazine and hydrogen sulfide, and non-reductive gases may for example include nitrogen, carbon dioxide, noble gases, and small amounts of oxygen. At S3, a plasma environment within the discharge cell is generated by applying high voltage to the electrodes, and at S4 contaminated water is introduced into the cell for purification. At S5, the treated water is discharged.

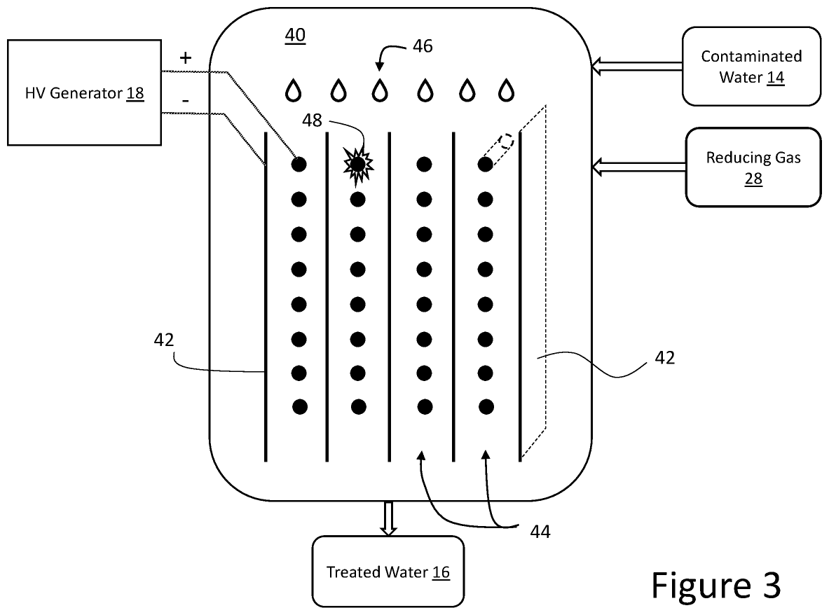

FIG. 3 depicts an illustrative embodiment of a discharge cell 40 having an electrode arrangement that includes a first group of electrodes 42 that comprise parallel plates and a second group of electrodes 44 that have rounded cross-sections and run horizontally in between the electrodes 42 (i.e., in and out of the page). When the water droplets 46 strike one of the second group of electrodes 44, a reaction 48 occurs that decontaminates the droplet.

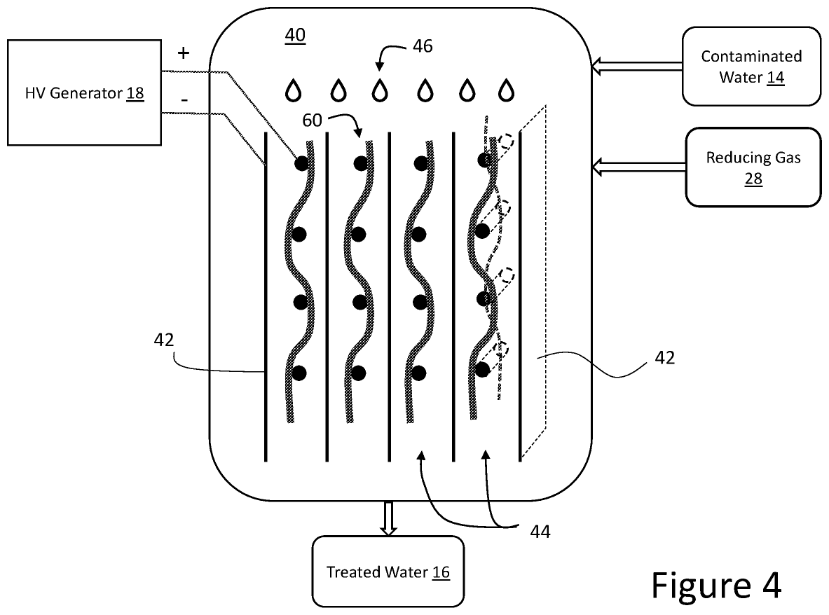

FIG. 4 depicts a similar electrode arrangement as that of FIG. 3, except the second group of electrodes 60 comprise a wire mesh (that runs vertically and horizontally in an out of the page).

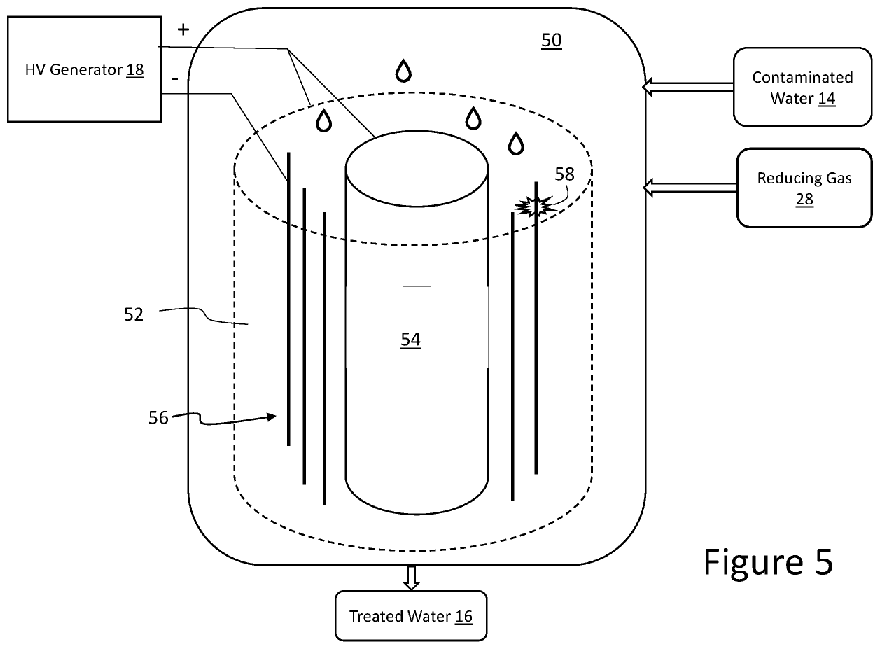

FIG. 5 depicts a further illustrative embodiment of a discharge cell 50 having an electrode arrangement that includes a first group of electrodes 52, 54 that comprise concentric tubes and a second group of electrodes 56 that include vertically oriented wires (e.g., having rounded cross-sections) with a substantially greater curvature than the concentric tubes. As the water droplets fall downward and strike the second group of electrodes 56, a reaction 58 occurs that decontaminates the water.

This approach accordingly utilizes a plasma environment to efficiently reduce fluorinated, chlorinated, and brominated organic compounds present in the contaminated water 14, as well as some oxygen and nitrogen-containing organic compounds and some inorganic compounds such as heavy metal ions. When subjected to the plasma environment created within the discharge cell, the persistent organic contaminants undergo chemical reactions, leading to their degradation and eventual elimination. In the case of inorganic contaminants, they are typically reduced to form elemental powders and can be subsequently removed by filtration. It is important to note that the capability for removal of organic compounds is not limited to halogen-containing compounds only, some non-halogenated organic compounds can undergo chemical transformation as well.

The invention described herein represents a significant advancement in the field of water treatment, specifically aimed at the elimination of persistent organic and toxic inorganic contaminants, including fluorinated, chlorinated, and brominated compounds, and heavy metals and non-metals ions, although not limited to these classes of contaminants. By harnessing the power of plasma within the discharge cell and optimizing various parameters, this technology offers an effective solution for the efficient removal of stubborn contaminants from water sources.

The innovative system described in this detailed description demonstrates the potential to greatly improve water quality, protect the environment, and contribute to the overall well-being of communities by ensuring access to safe and clean drinking water.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

1. A method for treating contaminated water, the method comprising:
providing a discharge cell having a first group of electrodes and a second group of electrodes arranged to provide a discharge zone therebetween;
filling the discharge cell with a reducing gas that includes at least one reductive gas selected from a group consisting of hydrogen, a gaseous organic compound, a vapour of a volatile organic compound, carbon monoxide, ammonia, hydrazine, and hydrogen sulfide;
applying high voltage to the first and second group of electrodes in the discharge cell to generate a plasma environment within the discharge zone that includes one of a pulsed corona or a barrier discharge; and
introducing contaminated water into the discharge zone and subjecting the contaminated water to the plasma environment to reduce at least one of persistent organic compounds or reducible inorganic compounds.

2. The method of claim 1, wherein the second group of electrodes have a curvature that is substantially greater than the first group of electrodes.

3. The method of claim 1, wherein the second group of electrodes comprise a wire mesh.

4. The method of claim 1, wherein the reducing gas further includes a non-reductive gas selected from a group consisting of nitrogen, carbon dioxide, oxygen, argon, helium, or another noble gas.

5. The method of claim 1, wherein the persistent organic compounds include at least one of fluorinated, chlorinated, and brominated compounds.

6. The method of claim 1, wherein the contaminated water is introduced using at least one of showering, pulverizing, or a free-flowing film.

7. The method of claim 1, wherein the discharge cell includes a dielectric barrier between the first group of electrodes and second group of electrodes.

8. The method of claim 1, wherein the contaminated water is passed through the discharge cell in a continuous flow process.

9. The method of claim 1, wherein the contaminated water is passed through the discharge cell in a batch processing mode.

10. The method of claim 1, wherein the plasma environment is configurable to reduce oxygen or nitrogen-containing compounds.

11. The method of claim 1, wherein the first group of electrodes comprise parallel plates and the second group of electrodes comprise wires running between the plates.

12. The method of claim 1, wherein the first group of electrodes comprise concentric tubes and the second group of electrodes comprise wires running between the tubes.

13. A system for treating contaminated water, the comprising:
a discharge cell having a first group of electrodes and a second group of electrodes arranged to provide a discharge zone therebetween;
a reducing gas configured for introduction into the discharge cell, wherein the reducing gas includes at least one reductive gas selected from a group consisting of hydrogen, a gaseous organic compound, a vapour of a volatile organic compound, carbon monoxide, ammonia, hydrazine and hydrogen sulfide;
a high voltage generator configured to apply high voltage to the first and second group of electrodes in the discharge cell to generate a plasma environment within the discharge zone that includes one of a pulsed corona or a barrier discharge; and
an inlet for introducing contaminated water into the discharge zone and subjecting the contaminated water to the plasma environment to reduce at least one of persistent organic compounds or reducible inorganic compounds.

14. The system of claim 13, wherein the reducing gas further includes a non-reductive gas selected from a group consisting of nitrogen, oxygen, carbon dioxide, argon, helium or another noble gas.

15. The system of claim 13, wherein the persistent organic compounds include at least one of fluorinated, chlorinated, and brominated compounds.

16. The system of claim 13, wherein the contaminated water is introduced using at least one of showering, pulverizing, or a free-flowing film.

17. The system of claim 13, wherein the discharge cell includes a dielectric barrier between the first group of electrodes and second group of electrodes.

18. The system of claim 13, wherein the contaminated water is passed through the discharge cell in one of a continuous flow process or a batch processing mode.

19. The system of claim 13, wherein the first group of electrodes comprise parallel plates and the second group of electrodes comprise wires running between the plates.

20. The system of claim 13, wherein the first group of electrodes comprise concentric tubes and the second group of electrodes comprise wires running between the tubes.
